(19) United States
(12) Patent Application Publication
(10) Pub. No.: US 2019/0120701 A1
(43) Pub. Date: Apr. 25, 2019

(54) REDUCED GRAPHENE OXIDE-SILVER NANOCOMPOSITE FILMS FOR TEMPERATURE SENSOR APPLICATION

(71) Applicant: INDIAN INSTITUTE OF SCIENCE, Bangalore (IN)

(72) Inventors: Nagarjuna NEELLA, Bangalore (IN); Venkateswarlu GADDAM, Bangalore (IN); Nayak Mangalore MANJUNATHA, Bangalore (IN); Dinesh Narasimhiah SUBRAHMANYAM, Bangalore (IN); Rajanna KONANDUR, Bangalore (IN)

(73) Assignee: INDIAN INSTITUTE OF SCIENCE, Bangalore (IN)

(21) Appl. No.: 16/090,737

(22) PCT Filed: Apr. 7, 2017
(86) PCT No.: PCT/IB2017/052017

§ 371 Date: Oct. 2, 2018

(30) Foreign Application Priority Data
Apr. 9, 2016 (IN) 201641012543

(51) Int. Cl. G01K 7/18; C01B 32/198

(52) U.S. Cl. CPC G01K 7/186; B82Y 15/00; C01B 32/198

(57) ABSTRACT

A nanocomposite has reduced Graphene oxide and silver nanoparticles. A method synthesizes a nanocomposite and fabricates a nanocomposite film on a substrate for sensor applications based on the principle of negative temperature coefficient (NTC) of piezoresistive temperature sensing elements.

### TECHNICAL FIELD

The present invention relates to the field of sensors. The invention relates nanocomposite film, a method of synthesis of nanocomposite film and fabrication of nanocomposite film on a substrate. The invention relates to the nanocomposite film of reduced graphene nanosheets and silver nanoparticles composite, a method of synthesis of nanocomposite film and thereafter fabrication of the nanocomposite film on a kapton membrane/sheet, for sensor applications.

### BACKGROUND OF INVENTION

Micro and Nano systems have been playing a key role in the development of miniaturized electronic devices for the past few decades. In the recent past, nanoscale materials are found to be attractive candidates for temperature sensing elements due to their unique and exceptional properties such as large surface to volume ratio and dimensionality. These materials potentially can be used as sensors with high performance, reduction in the device size and minimizing the power consumption.

In general, temperature sensors basically contain elements with the property of temperature-dependent electrical resistance. For example, one of such sensors is thermistor, which can be used in gas sensors, battery packs for optimization of battery life, integrated circuits and micro heaters. Although the conventional temperature sensors are well-known to have higher sensitivity, they exhibit lower response time and limit their temperature range. Also, ability of the devices to stretch or bend is limited and hence experiences deformation when they are mounted onto large curvatures. As flexibility is also one of the criteria for the electronic devices in the area of stretchable or bendable and wearable electronics, the present invention addresses the sensitivity, higher response time and flexibility aspects, thereby minimizing the device size and minimizing energy consumption.

Graphene, one of the allotropes of carbon, has been a topic of intensive research in the recent years, because of its unusual properties in terms of strength, electricity and heat conduction. These properties are attributed to the structure of graphene which consists of a single atomic layer of sp² two dimensional hybridized carbon atoms arranged in a honey comb like structure. Due to these properties graphene has found many applications in biomedical devices relating to gene delivery, drug delivery, bio imaging, cancer therapy, artificial muscles; in electronic devices such as in dye sensitized solar cell, liquid crystal devices, field emission devices, organic light emitting diodes, in sensors such as pH sensors, temperature sensors, pressure sensors, biosensors and the like; in energy storage devices such as Lithium ion batteries and supercapacitors. The temperature sensors measure the degree of hotness or coldness that is generated by an object or system. There are various type of temperature sensors such as Thermostats, Thermistors, Resistance Temperature Detector (RTD), Thermocouple, Radiation Thermometer, Thermal Imagers, Thermopiles and the like. Graphene sheets are hard to be incorporated and distributed for sensing application. Graphene and its derivatives of nanodimension are considered as materials having outstanding physical and chemical properties. Due to these properties, a lot of research is being carried out on graphene related materials for sensor applications.

In view of the limitations associated with the thermal sensors; there appears to be a need to develop a process for obtaining better materials for thermal sensors devoid of limitations in a cost effective way. The present work provides composition of reduced graphene oxide and silver metal nanocomposite films that can be used as temperature sensor on flexible substrates.

### SUMMARY OF INVENTION

Accordingly, the present invention provides piezo resistive nanocomposite of reduced graphene oxide (RGO) nanosheets along with silver nanoparticles in the ratio 2:1 wt/wt and a method of synthesis of nanocomposite and its application as a sensor by its fabrication on a flexible Kapton membrane/sheet. The sensing film is of ˜50 μm thick; exhibiting a negative temperature coefficient and sensitivity of −1.62×10⁻³ Ω/Ω/K and 0.40472 Ω/K respectively.

### BRIEF DESCRIPTION OF FIGURES

The features of the present invention can be understood in detail with the aid of appended figures. It is to be noted however, that the appended drawings illustrate only typical embodiments of this invention and are therefore not to be considered limiting of its scope for the invention.

FIG. 1: Schematic view of Graphene-Ag nanocomposite based Temperature Sensor.

FIG. 2: Photograph of the fabricated nanocomposite based Temperature Sensor.

FIG. 3: XRD phases of RGO nanosheets and RGO-Ag nanocomposite.

FIG. 4: shows the prepared RGO nanosheets surface morphology, confirming the loosely bound sheet like structure. FIG. 4(b) shows the distribution of Ag nanoparticles in the RGO-Ag nanocomposite.

FIG. 5: The Raman Spectroscopy of the RGO nanosheets and RGO-Ag nanocomposite system.

FIG. 6: The temperature setup of Hot-Cold measurement calibration system.

FIG. 7: The relative change in resistance with respect to temperature resulting in Temperature Coefficient of Resistance (TCR).

FIG. 8: R-T curve exhibits the behavior of linear relationship (a) Non-linearity-2014: 0.871% FSO, (b) Non-linearity-2016: 1.174% FSO, (C) Repeatability: 98.78% FSO, (d) Hysteresis of 2014: 1.143% FSO and 2016: 0.835% FSO.

FIG. 9: I-V measurement of RGO-Ag nanocomposite films of R1, R2 and Total R (combined resistance) resistors.

FIG. 10: Photograph of the commercial devices with the present invention (RGO-Ag nanocomposite) based temperature sensors mounted on isothermal base for comparative performance study and benchmarking.

FIG. 11(a-c): Comparative performance results of RGO-Ag and Commercial Temperature sensors (Pt100 and Thermistor 471).

### DESCRIPTION OF INVENTION

The foregoing description of the embodiments of the invention has been presented for the purpose of illustration. It is not intended to be exhaustive or to limit the invention to the precise form disclosed as many modifications and variations are possible in light of this disclosure for a person skilled in the art in view of the Figures, description and claims. It may further be noted that as used herein and in the appended claims, the singular “a” “an” and “the” include plural reference unless the context clearly dictates otherwise. Unless defined otherwise, all technical and scientific terms used herein have the same meanings as commonly understood by person skilled in the art.

The present invention is in relation to a composite material for sensing; comprising reduced graphene oxide and silver nano particles in the ratio 2:1 wt/wt; wherein the reduced graphene oxide is of thickness ranging from about 80±30 nm to about 200±30 nm and silver nano particles is of size ranging from about 30±5 nm to about 60±5 nm.

In an embodiment of the present invention, the reduced graphene oxide is of thickness 150±30 nm and silver nano particles is of size 50±5 nm. In another embodiment of the present invention, the material is for sensing temperature, strain, pressure, force, acoustic, speed, humidity, gas sensing and biological samples.

In another embodiment of the present invention, the material is for sensing temperature ranging from about −60° C. to 85° C.

The present invention is also in relation to a sensor (A) comprising composite material (1) of reduced graphene oxide and silver nano particles in the ratio 2:1 wt/wt; wherein the reduced graphene oxide is of thickness ranging from about 80±30 nm to about 200±30 nm and silver nano particles is of size ranging from about 30±5 nm to about 60±5 nm; embedded on a flexible substrate (2) and provided with electrical leads (4).

In another embodiment of the present invention, the sensor is encapsulated in a coating selected from a group comprising parylene, room temperature vulcanized silicone compound (RTV), preferably parylene.

In another embodiment of the present invention, the sensor is for sensing temperature, strain, pressure, force, acoustic, speed, humidity, gas sensing and biological samples, preferably temperature.

In another embodiment of the present invention, the weight of the sensor is abut 400 mg and response time is ranging from about 450 ms to about 500 ms.

The present invention is also in relation to a method of preparation of composite material for sensing, comprising reduced graphene oxide and silver nano particles in the ratio 2:1 wt/wt; wherein the reduced graphene oxide is of thickness ranging from about 80±30 nm to about 200±30 nm and silver nano particles is of size ranging from about 30±5 nm to about 60±5 nm, said method comprising acts of
a) mixing dried RGO powder and the silver nanoparticles in a solvent in ratio 2:1 wt/wt to obtain a mixture; and
b) transferring the mixture on to a mold and then on to flexible substrate to obtain the composite material.

In another embodiment of the present invention, the solvent is selected from a group comprising N-Methyl-2-pyrrolidone, Dimethyl formamide (DMF), Tetrahydrofuran (THF), acetone and water, preferably N-Methyl-2-pyrrolidone.

In another embodiment of the present invention, the reduced graphene oxide is prepared by the method comprising acts of
i. oxidising graphite powder using potassium permanganate, hydrogen peroxide and deionized water in presence of sulphuric acid to obtain graphite oxide;
ii. purifying the graphite oxide using hydrochloric acid and deionized water;
iii. grinding the graphene oxide sheets to a powder, diluting it with de-ionized water and ultra-sonicating the diluted mixture to obtain mixture containing nanosheets;
iv. exfoliating the graphite oxide to obtain graphene oxide sheets; and
v. reducing the graphene oxide with hydrazine hydrate solution, filtering and annealing at a temperature ranging from about 75° C. to about 85° C., preferably 80° C. for 2 hours to obtain reduced graphene oxide nanosheets.

The invention provide nanocomposite film comprising reduced graphene oxide (RGO) nanosheets of thickness ranging from about 80±30 nm to about 200±30 nm and silver nanoparticles ranging from about 30±5 nm to about 60±5 nm; preferably in the range of 150±30 nm and size 50±5 nm respectively. The embodiments also provide for a method of synthesis of the nanocomposite film and thereafter fabrication of the nanocomposite film on a flexible Kapton membrane/sheet substrate for sensor applications based on the principle of negative temperature coefficient (NTC) of piezoresistive temperature sensing element.

The synthesis of nanocomposite sensing film involves the following steps:

a) Synthesis of Graphene from oxidation of graphite powder by modified Hummers method:

Graphite, the raw material for the synthesis of graphite oxide is obtained from natural or synthetic source. Graphite powder is oxidized to produce graphite oxide, which can be readily dispersed in water or another polar solvent due to the presence of hydroxyl and epoxide groups across the basal planes of graphite oxide and carbonyl and carboxyl groups located at the edges.

Graphite oxide is then exfoliated by ultrasonication for 2 to 3 hours to form colloidal suspensions of monolayer, bilayer or a few layers of graphene oxide sheets in different solvents. Reduced graphene oxide is then obtained from exfoliated graphene oxide sheets through reduction method utilizing hydrazine hydrate (N₂H₄) as the reductant at about 95° C. by strong stirring for about 3-4 hr.

The solution is then filtered to obtain a filtrate of RGO of thickness ranging from about 80±30 nm to about 200±30 nm and dried at about 65° C. for 2 hr to obtain powder and the remaining solvent is removed. The residue obtained is pure form of RGO powder which is used further for the synthesis of the nanocomposite film.

b) commercially available Silver nano particles of size ranging from about 30±5 nm to about 60±5 nm procured from M/S. Siltech corporation conductive inks private limited, India is utilized.

c) Procedure for the synthesis of the nanocomposite film:

The dried RGO powder and the silver nanoparticles are dispersed in N-Methyl-2-pyrrolidone (NMP). The two compounds are then mixed in the weight ratio of 2:1 through ultrasonication process. A mask of micro design is used to fabricate the mold and the compound mixture of the nanocomposite film is transferred on the flexible substrate by drop casting method.

The XRD pattern of the nanocomposite composition of reduced graphene oxide and silver nanoparticles is as follows:

Crystal structure of silver coated reduced Graphene Oxide showed a peak at 38.20° indicating plane(111) of face centered cubic silver nano particle. The angles 44.57°, 64.70°, 77.64°, 81.91° indicates corresponding planes (111), (200), (220), (311) of d-spacing as 0.236, 0.205, 0.144, 0.123 nm.

A suitable substrate, for example Kapton sheets/membrane is selected and cleaned for fabrication of the nanocomposite film. A mask of micro design is used to fabricate the mold and the compound mixture of the nanocomposite film is transferred on the flexible substrate by drop casting method. The thickness of the sensing film is set at about ˜50 μm. The RGO-Ag nanocomposite film is annealed at about 80° C. for 1 hour. The electrical leads are then taken out with thin double enameled copper wires (70 μm, diameter) using silver paste on top corner of the nanocomposite patterned films. Also, the fully fabricated sensing film is annealed at 90° C. for 30 minutes for the purpose of curing of the silver paste with electrical contacts and making the device robust. Furthermore, the fabricated device is encapsulated from the environmental conditions with 1.5 μm thick Parylene coating. The device, when encapsulated with Parylene provides complete protection from the moisture, dust, peel off and scratches. Parylene when deposited gives the complete conformal, uniform thickness as well as pinhole free layer. Once Parylene is coated the device shows the stability and long life even at about 80° C. for 10 years. The structural active area of the device is around 4 mm×1 mm, which is integrated on the kapton sheets/membrane (10 mm×5 mm×0.175 mm) The thickness of active area varies with respect to the spacing between the adjacent ink droplets (nanocomposite solution) and the number of nanocomposite drops deposited, which has an influence on the electrical resistance.

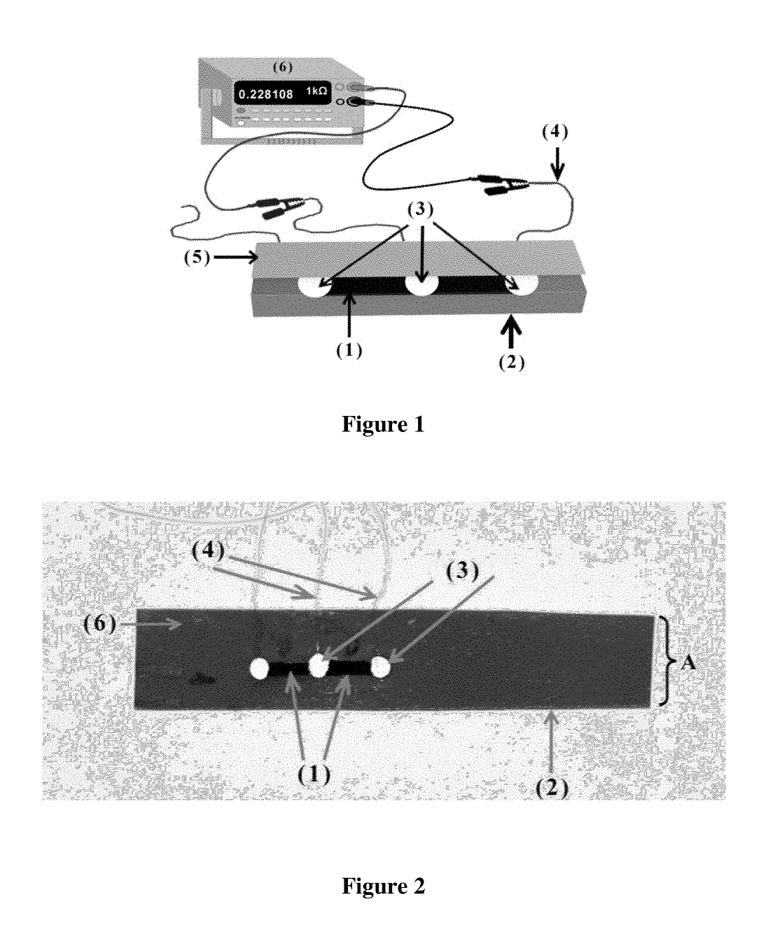

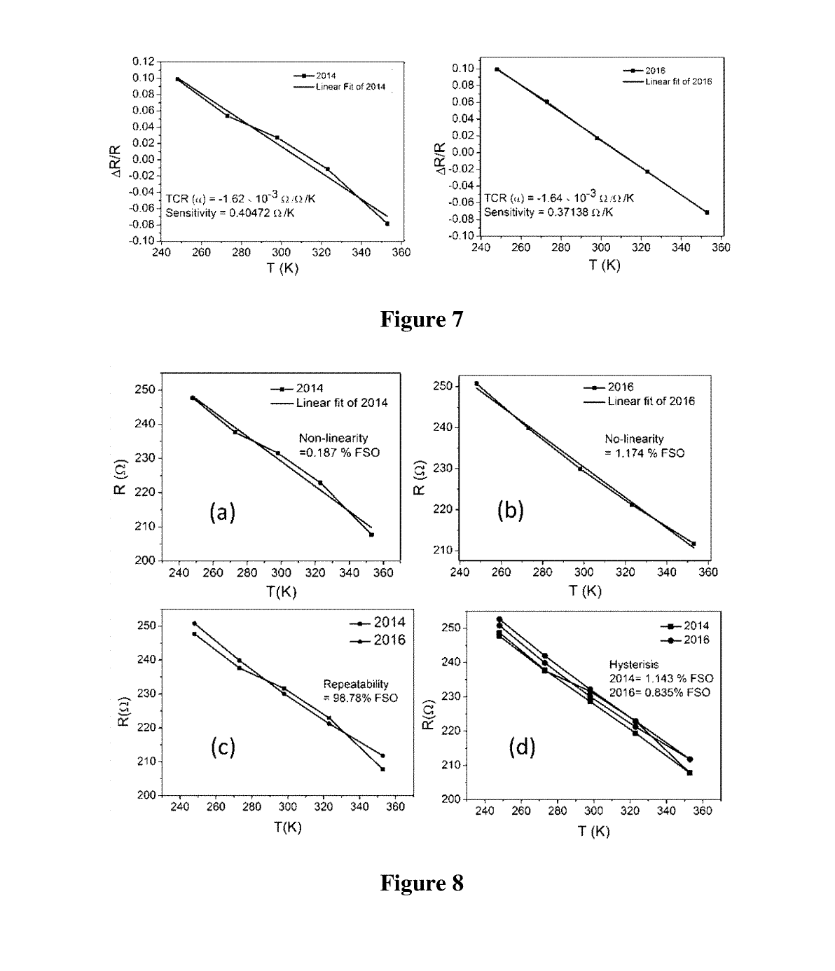

FIGS. 1 and 2 shows the schematic representation and photograph image of fabricated Graphene (RGO)-Silver nanoparticles based nanocomposite film for temperature sensor application. In order to study the performance of the resistive element sensor, it is placed inside a Hot-Cold enclosure to calibrate and study the performance as shown in FIG. 6. The resistive element is subjected to thermal heating environment by using temperature calibration system. After the realization of the nanocomposite sensing film, its resistance verses temperature response is studied and the typical responses obtained are shown in FIGS. 7 & 8.

The surface morphology analysis of as-synthesized RGO nanosheets and RGO-Ag nanocomposite is examined using field emission-scanning electron microscopy (FE-SEM (Carl Zeiss), ULTRA 55). FIG. 4(a) shows the prepared RGO nanosheets surface morphology, confirming the loosely bound sheet like structure. The distribution of Ag nanoparticles in the RGO-Ag nanocomposite can be clearly seen in FIG. 4(b). The presence of Ag nanoparticles distribution in the RGO matrix prevents the agglomeration of the nanosheets. The Ag nanoparticles are homogeneously distributed and intercalated RGO nanosheets are expected for the improved electrical performance of the nanocomposite system. In the nanocomposite system, the presence of Ag nanoparticles in the RGO nanosheets plays an important role such as a dispersing agent, reinforcement and formation of conduction path between the RGO nanosheets.

### a) X-Ray Diffraction Studies

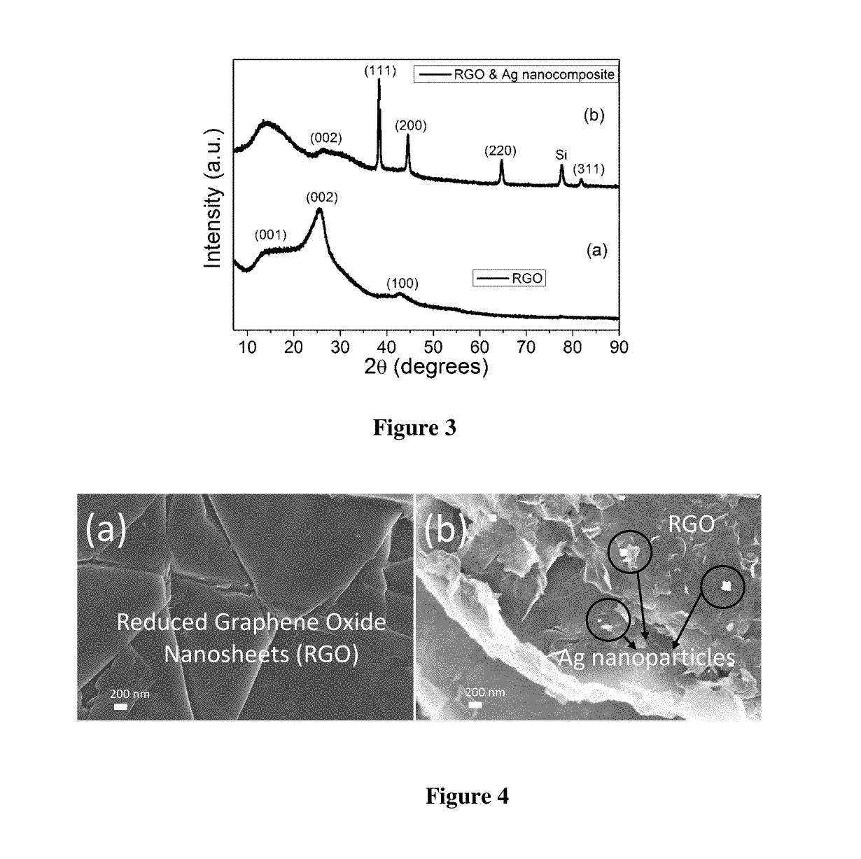

X-ray diffraction (XRD) patterns are recorded on the synthesized RGO nanosheets and RGO-Ag nanocomposite for their structural analysis. Crystal structure of silver coated reduced Graphene Oxide (RGO) shows a peak at 38.20° indicates plane (111) of face centered cubic silver nano particle. The angles 44.57°, 64.70°, 77.64°, 81.91° indicates corresponding planes(111), (200), (220), (311) of d-spacing as 0.236, 0.205, 0.144, 0.123 nm. The XRD pattern gives the existence of a broad peak at 2θ=25.61°, corresponding to the (002) plane of non-crystalline nature of RGO nanosheets and the (001) diffraction peak disappears in the RGO nanosheets, which indicate that the RGO nanosheets are reduced from Graphite oxide (GO). The diffraction peak at 42.82° corresponding to the (100) plane represents the reformation of graphite microcrystals nature in the RGO system as shown in FIG. 3. In the RGO-Ag nanocomposite system, Ag nanoparticles are decorated on the RGO nanosheets. Hence, the peak at 38.20° indicates the corresponding plane of (111) face centered cubic (FCC) Ag nanoparticles. The additional peaks at 44.57°, 64.70°, 77.64° and 81.91° indicates the corresponding planes (111), (200), (220) and (311) of Ag particles respectively. The observed other intensity peak at 25.61° corresponding to the plane of (002), which is related to the RGO nanosheets in the RGO-Ag nanocomposite system. However, the presence of high intensity sharp peaks corresponding to Ag nanoparticles can be clearly seen from FIG. 3.

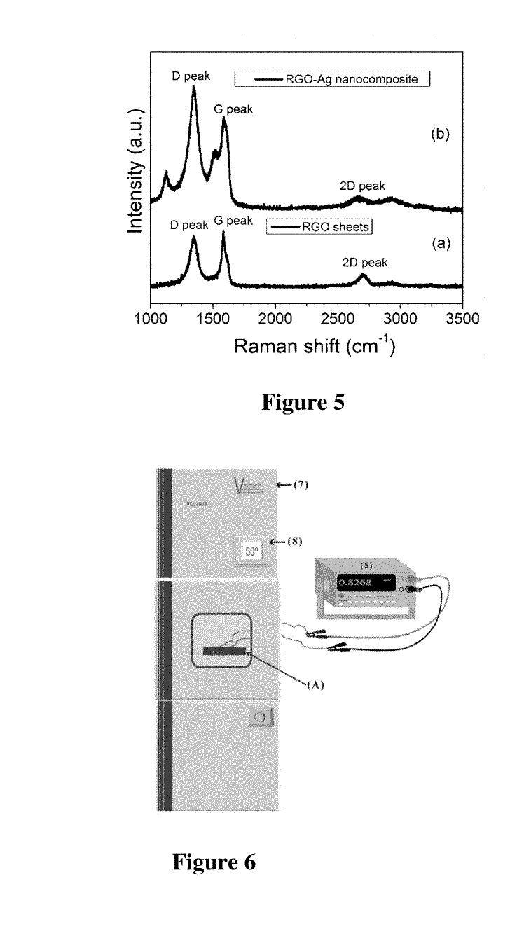

The information related structural characteristics and properties of graphene based materials are obtained from Raman Spectroscopy. The spectrum of RGO and RGO-Ag nanocomposite is shown in FIG. 5, which shows the existence of the D, G and 2D peaks. In the RGO, the demonstration of two peaks corresponding to the D-band at 1344.85 cm⁻¹ and G-band at 1589.67 cm⁻¹, which indicates the presence of structural defects in RGO nanosheets. The G line gives rise to the first order scattering of the E_{2g} phonon vibration mode of sp² bonded C atoms and the D line is the breathing mode of the K-point phonons of A_{1g} Symmetry. The 2D peak at 2709.38 cm⁻¹ is initiated from second order double resonant Raman Scattering, which varies the number of layers present in the material. The peak position of 2D is similar to the monolayer graphene prepared from the mechanical cleavage method. In the nanocomposite system, Raman intensities of the D peak at 1342.09 cm⁻¹ shows defects in the nanocomposite. The G peak at 1591.97 cm⁻¹ peak slightly increases upon the adsorption of silver nanoparticles with surface enhanced Raman scattering activity. The peak position of 2D at 2701.24 cm⁻¹ represents graphitic nature in the composite system after functionalizing with Ag nanoparticles. Furthermore, the presence of Ag nanoparticles in RGO-Ag nanocomposite heightens the relative intensity ratio of D/G changes by doping, which represent making the ideal tool to the degree of disorder in graphene for nano electronics.

### b) Studies on Performance of Sensor

The schematic view of the complete experimental set up is shown in FIG. 6. The electrical leads of the temperature sensor are connected to a 6½ digital multimeter (Gwinstek GDM-8261). The sensor is subjected to the heating by digital controlled environment. As the nanocomposite film is exposed to the hot environment, the conductance of nanocomposite film is highly sensitive to local electrical and chemical changes. The resistance of the sensor varies with respect to the temperature. It is observed that the fabricated nanocomposite film behaves like a negative temperature coefficient (NTC) sensing element, in which the electrical resistance decreases with the increase of temperature linearly as shown in FIG. 7 and FIG. 8. The NTC value of the Graphene-Ag nanocomposite films is found to be −1.62×10⁻³ Ω/Ω/K is shown in FIG. 7. The performance of temperature sensor in terms of the sensitivity is about 0.40472 Ω/K at the tested temperature range 248 K to 353 K as shown in FIG. 8.

The negative temperature coefficient of resistance (TCR) of the temperature sensor is calculated using the following equation

$$T C R ( α ) = \frac{{R}_{T} - {R}_{T 0}}{( T - {T}_{0} ) {R}_{T 0}} = \frac{Δ R}{R Δ T} Ω / Ω / Κ \qquad ( 1 )$$

Where α is the negative temperature coefficient of resistance of the temperature sensor, ΔR the change in resistance and R the initial resistance.

The sensitivity of the sensor is calculated at different time intervals using the following equation

$$Sensitivity = \frac{{R}_{T} - {R}_{T 0}}{( T - {T}_{0} )} = \frac{Δ R}{Δ T} Ω / Κ \qquad ( 2 )$$

In the year 2014 TCR is: −1.62×10⁻³ Ω/Ω/K, Sensitivity: 0.40472 Ω/K and

In the year 2016 is TCR is: −1.64×10⁻³ Ω/Ω/K, Sensitivity: 0.37138 Ω/K.

Further, the resistance verses temperature characteristics (non-linearity, hysteresis and repeatability) of RGO-Ag nanocomposite temperature sensor are calculated. Using the straight fit curve method, the non-linearity and hysteresis is found to be maximum of 0.871% full scale output (FSO) and the maximum of 1.143% full scale output (FSO) in the range of 248 K to 353 K respectively. The calculated root mean square (RMS) error and root sum square (RSS) error by considering the effect of maximum non-linearity and maximum hysteresis of about 1.02% and 1.44% of FSO respectively. The above characteristic measurements are carried out in the year 2014.

However, for the repeatability of the RGO-Ag nanocomposite temperature sensor, the above experiment is repeated in the year 2016. The measured repeatability of the sensor is about 98.78% of FSO. Hence, it can be concluded that the performance of fabricated RGO-Ag nanocomposite based temperature sensor is extremely good and repeatable even after 2 years. Furthermore, the calculated maximum non-linearity and maximum hysteresis of the sensor even in 2016 is 1.174% of FSO and 0.835% of FSO in the range of 248 K to 353 K respectively. The calculated root mean square (RMS) error and root sum square (RSS) error by considering the combined effect of maximum non-linearity, maximum hysteresis and non-repeatability works out to be 1.89% and 1.09% of FSO respectively.

### c) I-V Characterization

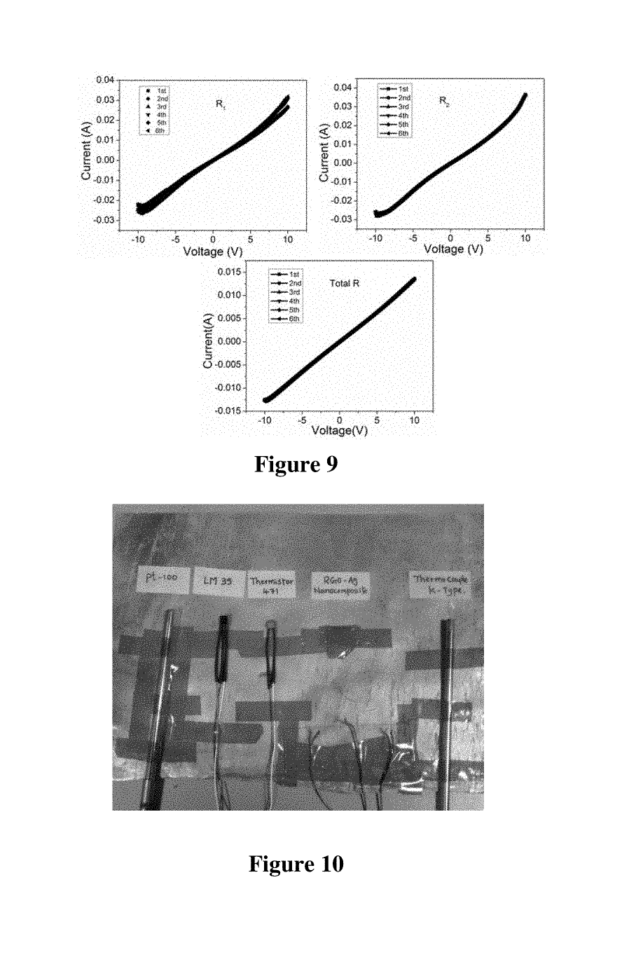

The I-V characterisation of RGO-Ag nanocomposite based temperature sensor/device is demonstrated. In this context, studied the I-V characterisation of individual resistors (R₁ and R₂) and combined resistance of R₁ and R₂ (Total R=R₁+R₂). FIG. 9 shows the current (I) verses voltage (V) behaviour of the fabricated RGO-Ag nanocomposite temperature sensor at room temperature for the device (two different resistors and total resistor). It is found that the current increases linearly with increase of voltage from −10 V to +10 V. The experiment is carried out for multiple cycles to check repeatability of the device performance. It is observed that, all of the resistors (R₁, R₂& Total R) show linear performance/behaviour, indicating the ohmic contact between the RGO-Ag nanocomposite and its electrodes. Similar experiments are conducted for different resistors and the obtained results are same as above. Therefore, silver nanoparticles can provide the conductive pathway to improve the electrical conductivity of graphene. In essence, the fabricated device show the faster electron transfer, which occurs between channel (RGO-Ag nanocomposite sensing element) and the electrodes. Hence, these results show good electrical conductivity of RGO-Ag nanocomposite films.

### d) Bench Marking Test

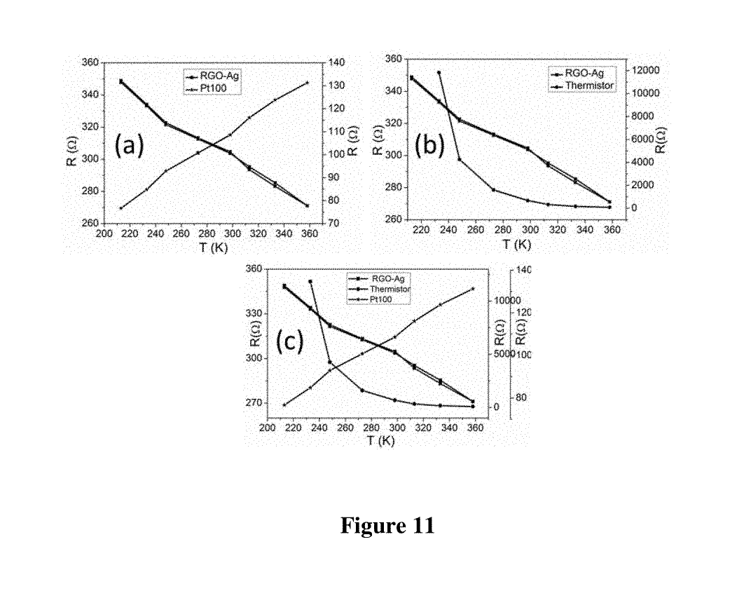

The temperature sensing property of presently developed/fabricated nanocomposite based RGO-Ag temperature sensor is tested experimentally and compared with the commercially available standard resistance based temperature sensors such as Pt 100, Thermistor 471. Also, the RGO-Ag sensor is compared with LM 35 and Thermocouple (K-type). FIG. 10 show the photograph of mounting arrangement of commercial devices with the present invention (RGO-Ag nanocomposite with encapsulated packaging of Al foil) based temperature sensors on an isothermal base for comparative performance study. The experiments are performed by keeping all the devices/sensors together in the hot-cold encloser calibration set up. The temperature and stabilization (1 hour) time are maintained for all the devices uniformly during the measurement. It has been observed that the resistance of Pt 100 decreases with the decrease of temperature indicating the positive temperature coefficient (PTC) behavior. Thermistor 471 and RGO-Ag nanocomposite show the increase of resistance with the decrease of temperature indicating the negative temperature coefficient (NTC) behavior. The invention addresses the NTC behavior, the resistance changes linearly with respect to the applied temperature in the range of 213 K to 353 K. The sensitivity (0.555 Ω/° C.) of the device is found to be better than the standard Pt 100 temperature sensor (0.38 Ω/° C.), which is shown in FIG. 11(a). Although, the thermistor (FIG. 11 (b)) shows better sensitivity (14.85 Ω/° C.) when compared to Pt 100 and RGO-Ag nanocomposite sensor, it exhibits non-linear behavior. These comparisons were observed by FIGS. 11(a-c). However, LM 35 and Thermocouple K-type cannot be compared with the present invention, due to the different type of the sensing mechanism.

response time for the above sensors (Pt 100, Thermistor and RGO-Ag) in cold bath are 22 Sec, 49.3 Sec and 470 m Sec respectively. Similarly, the observed response time in hot water bath for the same sensors are 17.5 Sec, 2.7 Sec and 3.45 Sec respectively. It is evident that the fabricated RGO-Ag sensor has better response time (470 m Sec) in comparison with the commercial Pt 100 (22.0 Sec) and thermistor 471 (49.3 Sec) sensors when it is in cold bath. Also, the fabricated RGO-Ag sensor has better response time (3.45 Sec) in comparison with commercial Pt 100 (17.5 Sec) when it is in hot bath.

The detailed comparative performance study data of the commercial and RGO-Ag nanocomposite temperature sensors are given in Table 1 below.

TABLE 1
Comparative performance study data of the commercial and RGO-Ag nanocomposite temperature sensors

| | | | | | | | | | | Thermocouple | |
|---|---|---|---|---|---|---|---|---|---|---|---|
| | | PT 100 SS | | | | RGO-Ag Al | | | | K-Type SS | |
| S. No | Parameters | Encapsulated | | Thermistor Bare | | Encapsulated | | LM35 Bare | | Encapsulated | |
| 1. | Sensing type | PTC | | NTC | | NTC | | Semiconductor | | Seebeck | |
| 2. | Sensitivity | 0.38 | Ω/° C. | 14.85 | Ω/° C. | 0.555 | Ω/° C. | 10 | mV/° C. | 41 | μV/° C. |
| 3. | TCR | 3.85 × 10⁻³ Ω/Ω/K | | −3.90 × 10⁻³ Ω/Ω/K | | −1.62 × 10^{- 3} Ω/Ω/K | | — | | — | |
| 4. | Linearity | Linear | | Non linear | | Linear | | Non-linear | | Linear | |
| 5. | Temperature Range | −50° C. to 230° C. | | −40° C. to 125° C. | | −60° C. to 170° C. | | −55° C. to 150° C. | | −300° C. to 1350° C. | |
| 6. | Weight | 36.87 | gm | 0.18 | gm | 0.4 | gm | 0.17 | gm | 56.29 | gm |
| 7. | Type of device | Metal | | Ceramics | | Nanocomposite | | Semiconductor | | Alloy | |
| 8. | Resistance/Voltage at 0° C. | 100 | Ω | 1532 | Ω | 313 | Ω | 1.733 | mV | 0.0105 | mV |

| | | | | | | |
|---|---|---|---|---|---|---|
| 9. | Response Time | Cold- 22.0 Sec | Cold- 49.3 Sec | Cold- 470 m Sec | — | — |
| | | Hot -17.5 Sec | Hot - 2.7 Sec | Hot - 3.45 Sec | | |
| 10. | Cost | High | Low | Very Low | Moderate | High |

In order to study the response time of the temperature sensors such as Pt 100, Thermistor and RGO-Ag, the experiments are conducted by dipping the sensors in ice bath and hot water bath for cold and hot responses. Care is taken to ensure that the device is fully in physical contact with proper thermal equilibrium between ices bath/hot bath and the device environment. The observed

In order to study the response time of the temperature sensors such as Pt 100, Thermistor and RGO-Ag, the experiments are conducted by dipping the sensors in ice bath and hot water bath for cold and hot responses. Care is taken to ensure that the device is fully in physical contact with proper thermal equilibrium between ices bath/hot bath and the device environment. The observed

The comparative performance study results for RGO-Ag and commercial temperature sensors such as Pt 100, thermistor 471 are shown in FIG. 10 (c). It can be clearly observed that Pt 100 and RGO-Ag sensors exhibit linear response compared to thermistor type sensor. Moreover, the TCR value (−1.62×10⁻³ Ω/Ω/K) for the presently developed RGO-Ag sensor is better than the Pt 100 (3.85×10⁻³ Ω/Ω/K) and Thermistor 471 (−3.9×10⁻³ Ω/Ω/K). Hence the presently developed sensor (RGO-Ag) can easily replace the thermistors type sensors in the market.

Further, as compared to the commercially available temperature sensing devices, the RGO-Ag nanocomposite based sensor has the advantage of simpler electronic circuitry, light weight and low cost with mass production.

### Experimental

1. Method of Preparation of Reduced Graphene Oxide Nanosheets from Graphite

a). Synthesis of Graphene Oxide (GO):

Graphene Oxide (GO) is synthesized by Modified Hummer's method as fine graphite powder exfoliating through chemical route. Typically, the graphite powder (2 μm) is oxidized using strong acidic environment H₂SO₄ (54 ml) through constant magnetic stirring maintained at below 5° C. The KMnO₄ (6 gm) is slowly added to the (H₂SO₄) solution over a period of 20 minutes. Then the concentrated solution is rigorously stirred up for about 40 min and deionized water (100 ml) is added dropwise to the solution on stirring for 90 min Later, the deionized water (200 ml) is again added to complete the oxidation reaction. The entire oxidation process is completed by adding 30 ml of hydrogen peroxide (H₂O₂) to the mixture. After few minutes, the colour of the reaction mixture changes from black to reddish brown indicating the end of the reaction process. The mixture is washed two to three times with Hydrochloric acid (HCl) solution and deionized water (DI) in order to remove metal ions and un-oxidized graphite from the reaction mixture. The mixture is filtered through Whatman filter paper by using vacuum filtration method to separate the unreacted components from the mixture and the filtration cake residue is collected at the end of the process. Finally, GO sheets powder is annealed at 90° C. for 8 hours and grinding the GO sheets for further purification process.

b). Synthesis of RGO Nanosheets:

The Graphene oxide powder is diluted with de-ionized water taken in a weight ratio of 1:1. The dilution was prepared 300 mg (1 mgml⁻¹) of Graphene oxide is dissolved in 300 ml of deionized water. The diluted suspension is ultra-sonicated (the operating frequency is about 33 K Hz±3%) for 90 min. The flakes of Graphene oxide are split into the individual nano sheets. The entire mixture is reduced using reducing agent, that is, 0.1 g (3 ml) Hydrazine hydrate solution is added to the mixture under constant stirring at 95° C. for 4 hours. The mixture is filtered through Whatman filter paper by using vacuum filtration method to separate the unreacted components from the mixture and the filtration cake residue is collected at the end of the process. Finally reduced graphene oxide nanosheets are annealed at 80° C. for 2 hours.

### 2. Method of Preratation of the RGO-Ag Composite

The dried RGO powder and the silver nanoparticles are mixed in the weight ratio of 2:1, dispersed in N-Methyl-2-pyrrolidone (NMP, ˜1 ml) organic solvent through ultrasonication process. The diluted suspension is ultra-sonicated (the operating frequency is about 33 K Hz±3%) for 90 min. The reduced Graphene Oxide sheets and Ag nanoparticles are mixed in order to achieve the homogenous composition. Subsequently, this composition is used for the fabrication of flexible temperature sensor sensing element.

### 3. Method of Fabrication of the Device

A Stainless steel sheet mask of micro design is used to fabricate the mold and the compound mixture of the nanocomposite film is transferred on the flexible substrate by drop casting method. The thickness of the sensing film is set at about ˜50 μm. The RGO-Ag nanocomposite film is annealed at about 80° C. for 1 hour. The electrical leads are then taken out with thin double enameled copper wires (70 μm, diameter) using silver paste on top corner of the nanocomposite patterned films. Also, the fully fabricated sensing film is annealed at 90° C. for 30 minutes for the purpose of curing of the silver paste with electrical contacts and making the device robust. Furthermore, the fabricated device is encapsulated from the environmental conditions with 1.5 μm thick Parylene coating. The device, when encapsulated with Parylene provides complete protection from the moisture, dust, peel off and scratches. Parylene when deposited gives the complete conformal, uniform thickness as well as pinhole free layer. Once Parylene is coated the device shows the stability and long life even at about 80° C. for 10 years.

FIGS. 1 & 2 shows the schematic representation and photograph image of fabricated sensor (A) comprises of reduced Graphene Oxide-Ag nanocomposite (1) based temperature sensor on a flexible substrate (2) silver paste contacts (3) and attached copper wires (4) electrodes for regulating electric flow measuring with digital multimeter, GwIntek (5). The setup of nanocomposite fabricated is encapsulated using Parylene (6) to protect the sensor from external agents such as moisture, dust, humidity and the like.

In order to study the performance of the nanocomposite based sensor, the sensor (A) is placed inside the Hot-Cold measurement system (7) with a digital controlled meter (8) in the calibration system as shown in FIG. 6.

In conclusion, since the response of the RGO-Ag sensor is linear and repeatable with respect to the temperature variation; the electronic readout circuitry becomes simpler. In present invention, the effectiveness of nanocomposite on the flexible platform enabling the possibility of using it as a temperature sensor is clearly demonstrated and the performance is attributed to the reduced Graphene oxide nanosheets prepared by the unique modified Hummer's method. The method helps in the reduction of impurities within the reduced graphene sheets. The fabricated sensor is compact in size, low cost and flexible.

Thus, the present invention (RGO-Ag nanocomposite) is a good potential candidate for temperature sensor applications. the response of the device is linear and repeatable with respect to the temperature variation, the electronic readout circuitry becomes simpler. The effectiveness of nanocomposite on the flexible platform enabling it as a temperature sensor is demonstrated. The fabricated sensor is a compact size, low cost and flexible temperature sensor. The same sensor can be applied for strain, pressure, force, acoustic, speed, humidity, gas sensing and biological sensing.

The aforesaid description is enabled to capture the nature of the invention. It is to be noted however that the aforesaid description and the appended figures illustrate only a typical embodiment of the invention and therefore not to be considered limiting of its scope for the invention may admit other equally effective embodiments.

It is an object of the appended claims to cover all such variations and modifications that can come within the true spirit and scope of the invention.

1. A composite material for sensing; comprising reduced graphene oxide and silver nano particles in the ratio 2:1 wt/wt; wherein the reduced graphene oxide is of thickness ranging from about 80±30 nm to about 200±30 nm and silver nano particles is of size ranging from about 30±5 nm to about 60±5 nm.

2. The composite material as claimed in claim 1, wherein the reduced graphene oxide is of thickness 150±30 nm and silver nano particles is of size 50±5 nm.

3. The composite material as claimed in claim 1, wherein the material is for sensing temperature, strain, pressure, force, acoustic, speed, humidity, gas sensing and biological samples.

4. The composite materials as claimed in claim 1, wherein the material is for sensing temperature ranging from about −60° C. to 85° C.

5. A sensor comprising composite material of reduced graphene oxide and silver nano particles in the ratio 2:1 wt/wt; wherein the reduced graphene oxide is of thickness ranging from about 80±30 nm to about 200±30 nm and silver nano particles is of size ranging from about 30±5 nm to about 60±5 nm; embedded on a flexible substrate and provided with electrical leads.

6. The sensor as claimed in claim 5, wherein the sensor is encapsulated in a coating selected from a group consisting of parylene, room temperature vulcanized silicone compound.

7. The sensor as claimed in claim 5, wherein the sensor is for sensing temperature, strain, pressure, force, acoustic, speed, humidity, gas sensing and biological samples.

8. The sensor as claimed in claim 5, wherein the weight of the sensor is about 400 mg and response time is ranging from about 450 ms to about 500 ms.

9. A method of preparation of composite material for sensing, comprising reduced graphene oxide and silver nano particles in the ratio 2:1 wt/wt; wherein the reduced graphene oxide is of thickness ranging from about 80±30 nm to about 200±30 nm and silver nano particles is of size ranging from about 30±5 nm to about 60±5 nm, said method comprising acts of
a) mixing dried RGO powder and the silver nanoparticles in a solvent in ratio 2:1 wt/wt to obtain a mixture; and
b) transferring the mixture on to a mold and then on to flexible substrate to obtain the composite material.

10. The method of preparation of composite material as claimed in claim 9, wherein the solvent is selected from a group consisting of N-Methyl-2-pyrrolidone, Dimethyl formamide (DMF), Tetrahydrofuran (THF), acetone and water.

11. The method of preparation of composite material as claimed in claim 9, wherein the reduced graphene oxide is prepared by the method comprising acts of
i. oxidising graphite powder using potassium permanganate, hydrogen peroxide and deionized water in presence of sulphuric acid to obtain graphite oxide;
ii. purifying the graphite oxide using hydrochloric acid and deionized water;
iii. grinding the graphene oxide sheets to a powder, diluting it with de-ionized water and ultra-sonicating the diluted mixture to obtain mixture containing nanosheets;
iv. exfoliating the graphite oxide to obtain graphene oxide sheets; and
v. reducing the graphene oxide with hydrazine hydrate solution, filtering and annealing at a temperature ranging from about 75° C. to about 85° C.
